(19) United States
(12) Patent Application Publication
(10) Pub. No.: US 2011/0269023 A1
(43) Pub. Date: Nov. 3, 2011

(54) POWER STORAGE DEVICE

(75) Inventors: Takahiro KAWAKAMI, Atsugi (JP); Masaki YAMAKAJI, Atsugi (JP); Nadine TAKAHASHI, Yamato (JP); Shunpei YAMAZAKI, Tokyo (JP)

(73) Assignee: SEMICONDUCTOR ENERGY LABORATORY CO., LTD., Atsugi-shi (JP)

(21) Appl. No.: 13/093,067

(22) Filed: Apr. 25, 2011

(30) Foreign Application Priority Data
Apr. 28, 2010 (JP) 2010-104610

(51) Int. Cl. H01M 4/36

(52) U.S. Cl. 429/221; 429/223; 429/224

(57) ABSTRACT

A power storage device including a positive electrode having a positive electrode active material and a positive electrode current collector; and a negative electrode which faces the positive electrode with an electrolyte provided between the negative electrode and the positive electrode is provided. The positive electrode active material includes a first region which includes a phosphate compound containing lithium and nickel; and a second region which covers the first region and includes a compound containing lithium and one or more of iron, manganese, and cobalt, but not containing nickel. Since the entire superficial portion of a particle of the positive electrode active material does not contain nickel, nickel is not in contact with an electrolyte solution; thus, generation of a catalyst effect of nickel can be suppressed, and a high discharge potential of nickel can be utilized.

### BACKGROUND OF THE INVENTION

1. Field of the Invention

One embodiment of the disclosed invention relates to a power storage device.

2. Description of the Related Art

The field of portable electronic devices such as personal computers and cellular phones has progressed significantly. The portable electronic device needs a chargeable power storage device having high energy density, which is small, lightweight, and reliable. As such a power storage device, for example, a lithium-ion secondary battery is known. In addition, development of electrically propelled vehicles on which secondary batteries are mounted has also been progressing rapidly from a rise of growing awareness to environmental problems and energy problems.

In a lithium-ion secondary battery, as a positive electrode active material, a phosphate compound having an olivine structure and containing lithium (Li) and iron (Fe), cobalt (Co), or nickel (Ni), such as lithium iron phosphate (LiFePO₄), lithium cobalt phosphate (LiCoPO₄), or lithium nickel phosphate (LiNiPO₄), has been known (see Patent Document 1, Non-Patent Document 1, and Non-Patent Document 2).

Lithium iron phosphate is expressed by a composition formula, LiFePo₄, and FePO₄ which is formed by completely extracting lithium from LiFePo₄ is also stable; thus, high capacity can be safely achieved with lithium iron phosphate.

### REFERENCE

### [Patent Document]

[Patent Document 1] Japanese Published Patent Application No. H11-25983

### [Non-Patent Document]

### [Non-Patent Document 1] Byoungwoo Kang, Gerbrand Ceder, “Nature”, (United Kingdom of Great Britain and Northern Ireland), 2009, March, Vol. 458, pp. 190-193

### [Non-Patent Document 2] F. Zhou et al., “Electrochemistry Communications”, (Kingdom of the Netherlands), 2004, November, Vol. 6, No. 11, pp. 1144-1148

### SUMMARY OF THE INVENTION

A positive electrode active material which includes a phosphate compound having an olivine structure and containing lithium and nickel described above is expected to have a higher discharge potential than a positive electrode active material which includes a phosphate compound having an olivine structure and containing lithium and iron, but not containing nickel. The theoretical capacity of a phosphate compound having an olivine structure and containing lithium and nickel (e.g., general formula: LiNiPO₄) and that of a phosphate compound having an olivine structure and containing lithium and iron, but not containing nickel (e.g., general formula: LiFePO₄) are almost the same. Accordingly, a positive electrode active material which includes a phosphate compound having an olivine structure and containing lithium and nickel is expected to have high energy density.

However, even when a positive electrode active material which includes a phosphate compound having an olivine structure and containing lithium and nickel is used, the expected potential has not been obtained. One reason of this is thought to be decomposition of an electrolyte solution (an organic solvent).

Nickel atoms included in a phosphate compound having an olivine structure and containing lithium and nickel, which is a positive electrode active material, might function as a catalyst for an oxidation-reduction reaction of an organic substance included in an electrolyte solution. Therefore, when a nickel metal or a nickel compound included in the positive electrode active material is in contact with the electrolyte solution, there is a possibility that an oxidation-reduction reaction of the organic substance included in the electrolyte solution is promoted and the electrolyte solution is decomposed.

Further, in the case where the nickel metal or the nickel compound which is a raw material of the positive electrode active material remains without being reacted in the formation process and is mixed with the positive electrode active material, the remaining raw material might function as a catalyst for the oxidation-reduction reaction of the organic substance included in the electrolyte solution. Therefore, there is a possibility that the oxidation-reduction reaction of the organic substance included in the electrolyte solution is promoted and the electrolyte solution is decomposed.

In view of the above problems, an object of one embodiment of the disclosed invention is to provide a power storage device having high energy density.

One embodiment of the present invention is a positive electrode active material including a first region which includes a compound containing lithium (Li) and nickel (Ni); and a second region which covers the first region and includes a compound containing lithium (Li) and one or more of iron (Fe), manganese (Mn), and cobalt (Co), but not containing nickel (Ni).

One embodiment of the present invention is a power storage device including a positive electrode in which a positive electrode active material is formed over a positive electrode current collector; and a negative electrode which faces the positive electrode with an electrolyte provided between the negative electrode and the positive electrode. The positive electrode active material includes a first region which includes a compound containing lithium and nickel; and a second region which covers the first region and includes a compound containing lithium and one or more of iron, manganese, and cobalt, but not containing nickel.

The positive electrode active material is in particle form, and a positive electrode active material layer described later includes a plurality of particles.

That is, one embodiment of the present invention is a particle of a positive electrode active material including a first region which is located on the center side of the particle of the positive electrode active material and includes a compound containing lithium and nickel; and a second region which covers the entire surface of the first region and includes a compound containing lithium and one or more of iron, manganese, and cobalt, but not containing nickel. Since the entire superficial portion of the particle of the positive electrode active material does not contain nickel, nickel is not in contact with an electrolyte solution; thus, generation of a catalyst effect of nickel can be suppressed, and a high discharge potential of nickel can be utilized.

The first region may include a phosphate compound containing nickel. The second region may include a phosphate compound not containing nickel. As a typical example of a phosphate compound, a phosphate compound having an olivine structure can be given. A phosphate compound having an olivine structure and containing nickel may be used for the first region. A phosphate compound having an olivine structure and not containing nickel may be used for the second region. Further, a phosphate compound having an olivine structure may be used for both the first region and the second region.

Another embodiment of the present invention is a power storage device including a positive electrode in which a positive electrode active material is formed over a positive electrode current collector; and a negative electrode which faces the positive electrode with an electrolyte provided therebetween. The positive electrode active material includes a first region including a substance expressed by a general formula, Li₁₋ₓ₁Ni_{y}M_{1-y}PO₄ (x1 is greater than or equal to 0 and less than or equal to 1; M is one or more of Fe, Mn, and Co; and y is greater than 0 and less than or equal to 1); and a second region covering the first region and including a substance expressed by a general formula, Li₁₋ₓ₂MePO₄ (x2 is greater than or equal to 0 and less than or equal to 1; and Me is one or more of Fe, Mn, and Co). M is one or more elements of Fe, Mn, and Co, and in addition, Me is one or more elements of Fe, Mn, and Co. In the case where M and Me are two or more elements of Fe, Mn, and Co, there is no particular limitation on the ratio of the constituent elements.

The case where M in the substance expressed by the general formula, Li₁₋ₓ₁Ni_{y}M_{1-y}PO₄ (x1 is greater than or equal to 0 and less than or equal to 1; M is one or more of Fe, Mn, and Co; and y is greater than 0 and less than or equal to 1), is one or more elements is described below.

In the case where M is one element of Fe, Mn, and Co, the substance included in the first region is expressed by a general formula, Li₁₋ₓ₁Niₐ(M1)_{b}PO₄ (x1 is greater than or equal to 0 and less than or equal to 1; M1 is one of Fe, Mn, and Co; and a+b=1, a is greater than 0 and less than 1, and b is greater than 0 and less than 1).

In the case where M is two elements of Fe, Mn, and Co, the substance included in the first region is expressed by a general formula, Li₁₋ₓ₁Niₐ(M1)_{b}(M2)_{c}PO₄ (x1 is greater than or equal to 0 and less than or equal to 1; M1≠M2, M1 and M2 are each one of Fe, Mn, and Co; and a+b+c=1, a is greater than 0 and less than 1, b is greater than 0 and less than 1, and c is greater than 0 and less than 1).

In the case where M is three elements of Fe, Mn, and Co, the substance included in the first region is expressed by a general formula, Li₁₋ₓ₁Niₐ(M1)_{b}(M2)_{c}(M3)_{d}PO₄ (x1 is greater than or equal to 0 and less than or equal to 1; M1≠M2, M1≠M3, M2≠M3, and M1, M2, and M3 are each one of Fe, Mn, and Co; and a+b+c+d=1, a is greater than 0 and less than 1, b is greater than 0 and less than 1, c is greater than 0 and less than 1, and d is greater than 0 and less than 1).

The case where Me in the substance expressed by the general formula, Li₁₋ₓ₂MePO₄ (x2 is greater than or equal to 0 and less than or equal to 1; and Me is one or more of Fe, Mn, and Co), is one or more elements is described below.

In the case where Me is one element of Fe, Mn, and Co, the substance included in the second region is expressed by a general formula, Li₁₋ₓ₂(Me1)PO₄ (x2 is greater than or equal to 0 and less than or equal to 1; and Me1 is one of Fe, Mn, and Co).

In the case where Me is two elements of Fe, Mn, and Co, the substance included in the second region is expressed by a general formula, Li₁₋ₓ₂(Me1)ₐ(Me2)_{b}PO₄ (x2 is greater than or equal to 0 and less than or equal to 1; Me1≠Me2, and Me1 and Me2 are each one of Fe, Mn, and Co; and a+b=1, a is greater than 0 and less than 1, and b is greater than 0 and less than 1).

In the case where Me is three elements of Fe, Mn, and Co, the substance included in the second region is expressed by a general formula, Li₁₋ₓ₂(Me1)ₐ(Me2)_{b}(Me3)_{c}PO₄ (x2 is greater than or equal to 0 and less than or equal to 1; Me1≠Me2, Me2≠Me3, Me1≠Me3, and Me1, Me2 and Me3 are each one of Fe, Mn, and Co; and a+b+c=1, a is greater than 0 and less than 1, b is greater than 0 and less than 1, and c is greater than 0 and less than 1).

The substance expressed by the general formula, Li₁₋ₓ₁Ni_{y}M_{1-y}PO₄ (x1 is greater than or equal to 0 and less than or equal to 1; M is one or more of Fe, Mn, and Co; and y is greater than 0 and less than or equal to 1), may have an olivine structure.

The substance expressed by the general formula, Li₁₋ₓ₂MePO₄ (x2 is greater than or equal to 0 and less than or equal to 1; and Me is one or more of Fe, Mn, and Co), may have an olivine structure.

Since the axis directions of the crystal lattices of the first region and the second region are the same, the path (channel) of diffusion of lithium is not bent and lithium diffuses one-dimensionally; thus, charge and discharge are easily performed. Note that in this specification, the expression “the same” is used to mean also the case where a difference between the axis direction of the crystal lattice of the first region and that of the second region is within 10 degrees and they are substantially the same.

The first region preferably has a concentration gradient of nickel, in order to change continuously the lattice constant of the first region and the second region. When the lattice constant is continuously changed, stress or distortion is reduced; thus, diffusion of lithium is easily performed.

According to one embodiment of the disclosed invention, a power storage device having high discharge voltage and high energy density can be obtained.

### BRIEF DESCRIPTION OF THE DRAWINGS

FIG. 1 is a cross-sectional view of a positive electrode active material (in particle form) of the present invention.

FIG. 2 is a cross-sectional view of a power storage device.

FIG. 3 is a perspective view for illustrating an application mode of a power storage device.

### DETAILED DESCRIPTION OF THE INVENTION

Hereinafter, embodiments of the present invention will be described with reference to the drawings. Note that the present invention is not limited to the following description. The present invention can be implemented in various different ways and it will be readily appreciated by those skilled in the art that various changes and modifications are possible without departing from the spirit and the scope of the present invention. Therefore, the present invention should not be construed as being limited to the following description of the embodiments. Note that reference numerals denoting the same portions are commonly used in different drawings.

Note that the size, the thickness of a layer, and a region of each structure illustrated in the drawings and the like in the embodiments are exaggerated for simplicity in some cases. Therefore, the scale of each structure is not necessarily limited to that illustrated in the drawings.

Note that ordinal numbers such as “first”, “second”, and “third” in this specification are used in order to identify components, and the terms do not limit the components numerically.

### Embodiment 1

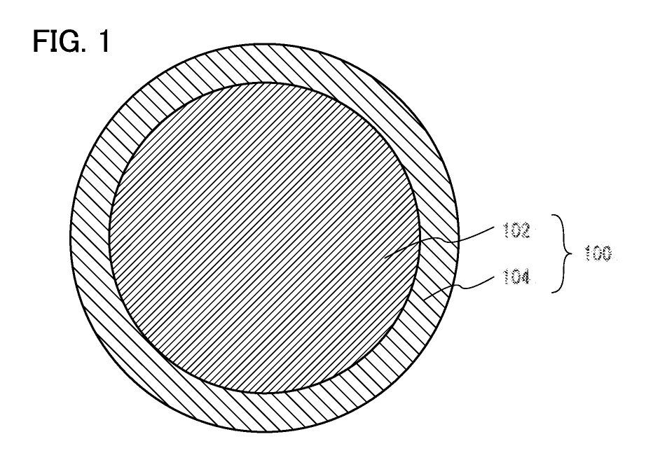

In this embodiment, a structure of a positive electrode active material which is one embodiment of the present invention will be described with reference to FIG. 1.

FIG. 1 is a schematic cross-sectional view of a positive electrode active material in particle form which is one embodiment of the present invention.

As illustrated in FIG. 1, in this embodiment, a positive electrode active material 100 includes a first region which includes a compound containing lithium and nickel (hereinafter, this region is referred to as a first region 102); and a second region which covers the entire surface of the first region 102 and includes a compound containing lithium and one or more of iron, manganese, and cobalt, but not containing nickel (hereinafter, this region is referred to as a second region 104).

The positive electrode active material is in particle form, and a positive electrode active material layer which is described later is formed using a plurality of particles of the positive electrode active material.

That is, the positive electrode active material 100 is formed of a particle of a positive electrode active material including the first region 102 which is located on the center side and includes a compound containing lithium and nickel; and the second region 104 which covers the entire surface of the first region and includes a compound containing lithium and one or more of iron, manganese, and cobalt, but not containing nickel. Since the entire superficial portion of the particle of the positive electrode active material is formed of the second region 104 which does not contain nickel, nickel is not in contact with an electrolyte solution; thus, generation of a catalyst effect of nickel can be suppressed, and a high discharge potential of nickel can be utilized.

The first region 102 may be formed using a phosphate compound containing nickel. As a typical example of a phosphate compound, a phosphate compound having an olivine structure can be given. A phosphate compound having an olivine structure and containing nickel may be used for the first region 102.

In the case where the first region 102 has an olivine structure, the first region 102 includes lithium, a transition metal, and phosphate (PO₄). As the transition metal, the one containing nickel and one or more of iron, manganese, cobalt, and nickel can be given. When the first region 102 includes nickel having a high oxidation-reduction potential, a high discharge potential is expected. Further, the higher the proportion of nickel in the first region 102 is, the higher the proportion of discharge capacity due to oxidation-reduction of nickel becomes, so that high energy density can be expected. In a general formula, Li₁₋ₓ₁Ni_{y}Me_{1-y}PO₄ (x1 is greater than or equal to 0 and less than or equal to 1; and Me is one or more of Fe, Mn, and Co), y is made to be greater than 0 and less than or equal to 1, preferably greater than or equal to 0.8, more preferably 1, whereby higher energy density can be expected.

The first region 102 may have a concentration gradient of nickel.

The first region 102 includes, as an impurity, a compound which does not function as a positive electrode active material (e.g., a material containing Ni) in some cases.

The second region 104 is preferably formed using a compound functioning as a positive electrode active material which contributes to charge and discharge, in order not to lead to a reduction in capacity.

Further, the second region 104 may be formed using a phosphate compound not containing nickel. As a typical example of a phosphate compound, a phosphate compound having an olivine structure can be given. A phosphate compound having an olivine structure may be used for the second region 104.

In the case where the second region 104 has an olivine structure, the second region 104 includes lithium, a transition metal, and phosphate (PO₄). As the transition metal, the one containing one or more of iron, manganese, and cobalt, but not containing nickel can be given. The second region 104 is expressed by a general formula, Li₁₋ₓ₂MeO₄ (x2 is greater than or equal to 0 and less than or equal to 1; and Me is one or more of Fe, Mn, and Co). Since the second region 104 also has an olivine structure, the second region 104 serves as capacity (component) in charge and discharge. However, a discharge potential is decreased and energy density is reduced because the second region 104 does not contain nickel. Therefore, the smaller the ratio c of the thickness d of the second region 104 to the grain size r of the particle of the positive electrode active material 100 (c=d/r) is, the better. The ratio c is preferably greater than or equal to 0.005 and less than or equal to 0.25, more preferably greater than or equal to 0.01 and less than or equal to 0.1. The ratio c may be changed as appropriate in accordance with the desired energy density.

Lithium is extracted from or inserted into the compounds in the first region 102 and the second region 104 in accordance with charge and discharge. Therefore, in a general formula of the substance included in the first region 102, Li₁₋ₓ₁Ni_{y}M_{1-y}PO₄ (x1 is greater than or equal to 0 and less than or equal to 1; M is one or more of Fe, Mn, and Co; and y is greater than 0 and less than or equal to 1), and in the general formula of the substance included in the second region 104, Li₁₋ₓ₂MePO₄ (x2 is greater than or equal to 0 and less than or equal to 1; and Me is one or more of Fe, Mn, and Co), x1 and x2 are each a given value in the range of 0 to 1. In some cases, the first region 102 and the second region 104 each have a concentration gradient of lithium.

For the compounds in the first region 102 and the second region 104, an alkali metal (e.g., sodium (Na) or potassium (K)) or an alkaline earth metal (e.g., beryllium (Be), magnesium (Mg), calcium (Ca), strontium (Sr), or barium (Ba)) can be used instead of lithium. Alternatively, for the compounds in the first region 102 and the second region 104, a compound containing lithium and one or more of an alkali metal and an alkaline earth metal can be used.

The positive electrode active material 100 described in this embodiment includes the first region 102 which is located on the center side and includes a compound containing lithium and nickel; and the second region 104 which covers the entire surface of the first region and includes a compound containing lithium and one or more of iron, manganese, and cobalt, but not containing nickel. Since the entire superficial portion of the particle of the positive electrode active material is formed of the second region 104 which does not contain nickel, nickel is not in contact with an electrolyte solution; thus, generation of a catalyst effect of nickel can be suppressed, and a high discharge potential of nickel can be utilized.

### Embodiment 2

In this embodiment, a positive electrode active material having higher discharge capacity and higher energy density than the positive electrode active material in Embodiment 1 will be described.

In this embodiment, the case where both the first region 102 and the second region 104 include a positive electrode active material having an olivine structure and containing a phosphate compound is described.

A substance included in the first region 102 has an olivine structure, and includes lithium, a transition metal, and phosphate (PO₄). The transition metal contains nickel and one or more of iron, manganese, cobalt, and nickel. The substance included in the first region 102 is expressed by the general formula, Li₁₋ₓ₁Ni_{y}Me_{1-y}PO₄ (x1 is greater than or equal to 0 and less than or equal to 1; Me is one or more of Fe, Mn, and Co; and y is greater than 0 and less than or equal to 1).

A substance included in the second region 104 has an olivine structure, and includes lithium, a transition metal, and phosphate (PO₄). The transition metal contains one or more of iron, manganese, and cobalt and does not contain nickel. The substance included in the second region 104 is expressed by the general formula, Li₁₋ₓ₂MePO₄ (x2 is greater than or equal to 0 and less than or equal to 1; and Me is one or more of Fe, Mn, and Co).

In the olivine structure, the diffusion path (channel) of lithium is one-dimensionally in a <010> direction. In the case where each of the first region 102 and the second region 104 includes a phosphate compound having an olivine structure, the diffusion paths (channels) of lithium of the first region 102 and the second region 104 are not bent and are aligned with each other when the axis directions of the crystal lattices of the first region 102 and the second region 104 are the same; therefore, charge and discharge are easily performed. It is preferable that a difference between the axis direction of the crystal lattice of the first region 102 and that of the second region 104 be within 10 degrees and they be substantially the same.

Since the first region 102 and the second region 104 include different constituent elements, the lattice constant of the crystal in the first region 102 and that in the second region 104 are different from each other. When the regions having different lattice constants are in contact with each other, there is a possibility that stress, lattice distortion, or lattice mismatch is generated at the boundary so that diffusion of lithium is inhibited. Thus, the first region preferably has a concentration gradient of nickel, in order to change continuously the lattice constant of the first region 102 and the second region 104. When the lattice constant is continuously changed, stress or distortion is reduced; thus, diffusion of lithium is easily performed.

In the positive electrode active material described in this embodiment, both the first region 102 and the second region 104 contain a phosphate compound having an olivine structure; thus, generation of a catalyst effect of nickel can be suppressed, and a high discharge potential of nickel can be utilized. In addition, charge and discharge are easily performed.

### Embodiment 3

In this embodiment, a method for forming a positive electrode active material which is one embodiment of the present invention will be described.

First, the first region 102 is formed.

The quantities of the materials at which a desired molar ratio can be obtained are weighed in accordance with the stoichiometric proportion of the general formula of the compound containing lithium and nickel, which is described in Embodiment 1 and 2. For example, in the case of the above phosphate compound having an olivine structure, the general formula, Li₁₋ₓ₁Ni_{y}Me_{1-y}PO₄ (x1 is greater than or equal to 0 and less than or equal to 1; Me is one or more of Fe, Mn, and Co; and y is greater than 0 and less than or equal to 1), is to be referred to. The weights of the materials are accurately weighed in accordance with a molar ratio of lithium:nickel:M:a phosphate group=1:y:(1−y):1 (note that y is greater than 0 and less than or equal to 1, preferably greater than or equal to 0.8, more preferably 1).

As a material containing lithium, lithium carbonate (LiCO₃), lithium hydroxide (Li(OH)), lithium hydroxide hydrate (Li(OH).H₂O), lithium nitrate (LiNO₃), and the like can be given. As a material containing iron, iron(II) oxalate dihydrate (Fe(COO)₂.2H₂O), iron chloride (FeCl₂), and the like can be given. As a material containing phosphate, diammonium hydrogen phosphate ((NH₄)₂HPO₄), ammonium dihydrogen phosphate (NH₄H₂PO₄), phosphorus pentoxide (P₂O₅), and the like can be given.

As a material containing manganese, manganese carbonate (MnCO₃), manganese chloride tetrachloride (MnCl₂.4H₂O), and the like can be given. As a material containing nickel, nickel oxide (NiO), nickel hydroxide (Ni(OH)₂), and the like can be given. As a material containing cobalt, cobalt carbonate (CoCO₃), cobalt chloride (CoCl₂), and the like can be given.

The materials containing any of metals such as lithium, iron, manganese, nickel, and cobalt are not limited to the respective above materials, and another oxide, carbonate, oxalate, chloride, hydrosulfate, or the like may be used.

The material containing phosphate is not limited to the above materials, and another material containing phosphate can be used.

The weighed materials are put in a mill machine and ground until the materials become fine powder (a first grinding step). At this time, it is better to use a mill machine made of a substance (e.g., agate) which prevents other metals from entering the materials. When a small amount of acetone, alcohol, or the like is added at this time, the materials are easily clumped together; thus, the materials can be prevented from being scattered as powder.

After that, the powder is subjected to a step of applying a first pressure and is thus molded into a pellet state. The pellet is put into a baking furnace, and heated. In such a manner, a first baking step is performed. Various degassing and thermal decomposition of the materials are substantially performed in this step. Through this step, a compound containing lithium and nickel is formed. For example, a phosphate compound having an olivine structure and containing lithium and nickel is formed.

After that, the pellet is introduced into the mill machine together with a solvent such as acetone, and is ground again (a second grinding step).

Next, the second region 104 is formed.

The quantities of the materials at which a desired molar ratio can be obtained are weighed in accordance with the stoichiometric proportion of the general formula of the compound containing lithium and one or more of iron, manganese, and cobalt, but not containing nickel, which is described in Embodiment 1 and 2. For example, in the case of a phosphate compound having an olivine structure, the general formula, Li₁₋ₓ₂MePO₄ (x2 is greater than or equal to 0 and less than or equal to 1; and Me is one or more of Fe, Mn, and Co), is to be referred to. The weights of the materials are accurately weighed in accordance with a molar ratio of lithium:M:a phosphate group=1:1:1.

The weighed materials are put in the mill machine and ground until the materials become fine powder (a third grinding step). At this time, it is better to use a mill machine made of a substance (e.g., agate) which prevents other metals from entering the materials. When a small amount of acetone, alcohol, or the like is added at this time, the materials are easily clumped together; thus, the materials can be prevented from being scattered as powder.

After that, the powder obtained through the second grinding step (a portion to be the first region 102) and the powder obtained through the third grinding step (a material for forming the second region 104) are sufficiently mixed with each other, subjected to a step of applying a second pressure, and molded into a pellet state. The pellet is put into a baking furnace, and heated. In such a manner, a second baking step is performed. Various degassing and thermal decomposition of the materials of the compound containing lithium and one or more of iron, manganese, and cobalt, but not containing nickel are substantially performed in this step. Through this step, the positive electrode active material 100 including the first region 102 which includes a compound containing lithium and nickel and the second region 104 which covers the entire surface of the first region 102 and includes a compound containing lithium and one or more of iron, manganese, and cobalt, but not containing nickel is formed. For example, the positive electrode active material 100 is formed, which includes the first region 102 that includes a phosphate compound having an olivine structure and containing lithium and nickel and the second region 104 that covers the entire surface of the first region 102 and includes a phosphate compound having an olivine structure and containing lithium and one or more of iron, manganese, and cobalt, but not containing nickel.

Even in the case where the material containing nickel remains in the first baking step, when it is covered with the compound not containing nickel in this step, nickel is not in contact with an electrolyte solution; thus, generation of a catalyst effect of nickel can be suppressed, and a high discharge potential of nickel can be utilized.

After that, the pellet is introduced into the mill machine together with a solvent such as acetone (a fourth grinding step). Next, the fine powder is molded again into a pellet state, and a third baking step is performed in the baking furnace. Through the third baking step, a plurality of particles of the positive electrode active material 100 can be formed, which includes the first region 102 that includes a compound containing lithium and nickel and the second region 104 that covers the entire surface of the first region 102 and includes a compound containing lithium and one or more of iron, manganese, and cobalt, but not containing nickel. For example, a plurality of particles of the positive electrode active material 100 including the first region 102 which includes a phosphate compound with high crystallinity having an olivine structure and containing lithium and nickel and the second region 104 which covers the entire surface of the first region 102 and includes a phosphate compound having an olivine structure and containing lithium and one or more of iron, manganese, and cobalt, but not containing nickel can be formed.

Note that in the third baking step, an organic compound such as glucose may be added. When the subsequent steps are performed after glucose is added, carbon supplied from the glucose is supported on the surface of the positive electrode active material.

Note that in this specification, a state in which a surface of a positive electrode active material is supported with a carbon material also means that an iron phosphate compound is carbon-coated.

The thickness of the supported carbon (a carbon layer) is greater than 0 nm and less than or equal to 100 nm, preferably greater than or equal to 2 nm and less than or equal to 10 nm.

By supporting carbon on the surface of the positive electrode active material, the conductivity of the surface of the positive electrode active material can be increased. In addition, when the positive electrode active materials are in contact with each other through carbon supported on the surfaces, the positive electrode active materials are electrically connected to each other; thus, the conductivity of the positive electrode active material layer described later can be further increased.

Note that although glucose is used in this embodiment as a carbon supply source because glucose easily reacts with a phosphate group, cyclic monosaccharide, straight-chain monosaccharide, or polysaccharide which reacts well with a phosphate group may be used instead of glucose.

The grain size of the particle of the positive electrode active material 100, which is obtained through the third baking step, is greater than or equal to 10 nm and less than or equal to 200 nm, preferably greater than or equal to 20 nm and less than or equal to 80 nm. The particle of the positive electrode active material is small when the grain size of the particle of the positive electrode active material is within the above range; therefore, lithium ions are easily inserted and eliminated. Thus, rate characteristics of a secondary battery are improved and charge can be performed in a short time.

As a formation method of the first region, a sol-gel method, a hydrothermal method, a coprecipitation method, a spray drying method, or the like may be used instead of the method described in this embodiment. Further, as a formation method of the second region, a sputtering method, a CVD method, a sol-gel method, a hydrothermal method, a coprecipitation method, or the like may be used instead of the method described in this embodiment.

According to this embodiment, a positive electrode active material that can suppress generation of a catalyst effect of nickel and utilize a high discharge potential of nickel can be formed.

### Embodiment 4

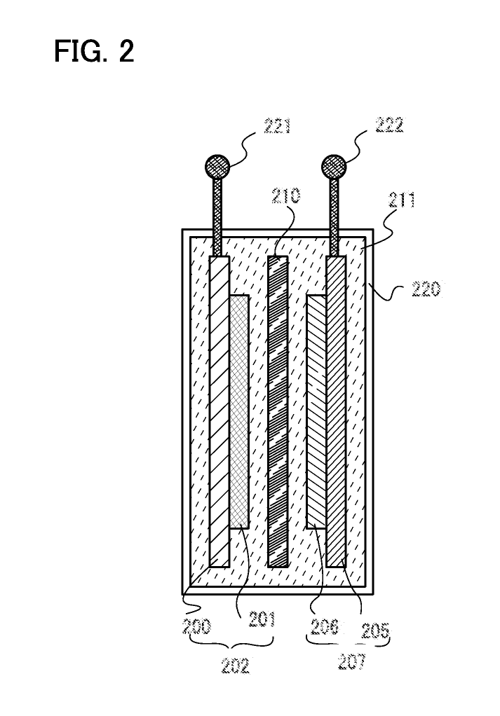

A lithium-ion secondary battery including a positive electrode active material obtained through the above steps will be described below. The schematic structure of the lithium-ion secondary battery is illustrated in FIG. 2.

In the lithium-ion secondary battery illustrated in FIG. 2, a positive electrode 202, a negative electrode 207, and a separator 210 are provided in a housing 220 which is isolated from the outside, and an electrolyte solution 211 is filled in the housing 220. In addition, the separator 210 is provided between the positive electrode 202 and the negative electrode 207. A first electrode 221 and a second electrode 222 are connected to a positive electrode current collector 200 and a negative electrode current collector 205, respectively, and charge and discharge are performed by the first electrode 221 and the second electrode 222. Moreover, there are certain gaps between a positive electrode active material layer 201 and the separator 210 and between a negative electrode active material layer 206 and the separator 210. However, the structure is not particularly limited thereto; the positive electrode active material layer 201 may be in contact with the separator 210, and the negative electrode active material layer 206 may be in contact with the separator 210. Further, the lithium-ion secondary battery may be rolled into a cylinder shape with the separator 210 provided between the positive electrode 202 and the negative electrode 207.

The positive electrode active material layer 201 is formed in contact with the positive electrode current collector 200. The positive electrode active material layer 201 includes the positive electrode active material 100 which is formed in Embodiment 3. The positive electrode active material 100 includes the first region 102 which includes a compound containing lithium and nickel and the second region 104 which covers the entire surface of the first region 102 and includes a compound containing lithium and one or more of iron, manganese, and cobalt, but not containing nickel. On the other hand, the negative electrode active material layer 206 is formed in contact with the negative electrode current collector 205. In this specification, the positive electrode active material layer 201 and the positive electrode current collector 200 over which the positive electrode active material layer 201 is formed are collectively referred to as the positive electrode 202. The negative electrode active material layer 206 and the negative electrode current collector 205 over which the negative electrode active material layer 206 is formed are collectively referred to as the negative electrode 207.

Note that the “active material” refers to a material that relates to insertion and elimination of ions which function as carriers and does not include a carbon layer including glucose, or the like. When the positive electrode 202 is formed by a coating method which will be described later, the active material including a carbon layer is mixed with another material such as a conduction auxiliary agent, a binder, or a solvent and is formed as the positive electrode active material layer 201 over the positive electrode current collector 200. Thus, the active material and the positive electrode active material layer 201 are distinguished.

As the positive electrode current collector 200, a material having high conductivity such as aluminum or stainless steel can be used. The electrode current collector 200 can have a foil shape, a plate shape, a net shape, or the like as appropriate.

As the positive electrode active material, the positive electrode active material 100 is used. The positive electrode active material 100 includes the first region 102 which includes a compound containing lithium and nickel and the second region 104 which covers the entire surface of the first region 102 and includes a compound containing lithium and one or more of iron, manganese, and cobalt, but not containing nickel. For example, the positive electrode active material 100 is used, which includes the first region 102 including a substance that has an olivine structure and is expressed by the general formula, Li₁₋ₓ₁Ni_{y}M_{1-y}PO₄ (x1 is greater than or equal to 0 and less than or equal to 1; M is one or more of Fe, Mn, and Co; and y is greater than 0 and less than or equal to 1); and the second region 104 covering the first region 102 and including a substance that has an olivine structure and is expressed by the general formula, Li₁₋ₓ₂MePO₄ (x2 is greater than or equal to 0 and less than or equal to 1; and Me is one or more of Fe, Mn, and Co).

After the third baking step described in Embodiment 3, the obtained positive electrode active material is ground again (a fifth grinding step) with the mill machine; thus, fine particles are obtained. The obtained fine particles are used as a positive electrode active material, to which a conduction auxiliary agent, a binder, or a solvent is added to obtain paste.

As the conduction auxiliary agent, a material which is itself an electron conductor and does not cause chemical reaction with other materials in a battery device may be used. For example, carbon-based materials such as graphite, carbon fiber, carbon black, acetylene black, and VGCF (registered trademark); metal materials such as copper, aluminum, and silver; and powder, fiber, and the like of mixtures thereof can be given. The conduction auxiliary agent is a material that assists conductivity between active materials: it is sealed between active materials which are apart and makes conduction between the active materials.

Note that examples of the binder include polysaccharides, thermoplastic resins, and polymers with rubber elasticity, and the like. For example, starch, carboxymethylcellulose, hydroxypropylcellulose, regenerated cellulose, diacetylcellulose, polyvinylchloride, polyvinylpyrrolidone, polytetrafluoroethylene, polyvinylide fluoride, polyethylene, polypropylene, ethylene-propylene-diene monomer (EPDM), sulfonated EPDM, styrene-butadiene rubber, butadiene rubber, fluorine rubber, or the like can be used. In addition, polyvinyl alcohol, polyethylene oxide, or the like may be used.

The active material, the conduction auxiliary agent, and the binder are mixed at 80 wt % to 96 wt %, 2 wt % to 10 wt %, and 2 wt % to 10 wt %, respectively, to be 100 wt % in total. Further, an organic solvent, the volume of which is approximately the same as that of the mixture of the active material, the conduction auxiliary agent, and the binder, is mixed therein and processed into a slurry state. Note that an object which is obtained by processing, into a slurry state, a mixture of the active material, the conduction auxiliary agent, the binder, and the organic solvent is referred to as slurry. As the solvent, N-methyl-2-pyrrolidone, lactic acid ester, or the like can be used. The proportions of the active material, the conduction auxiliary agent, and the binder are preferably adjusted as appropriate in such a manner that, for example, when the active material and the conduction auxiliary agent have low adhesiveness at the time of film formation, the amount of binder is increased, and when the electrical resistance of the active material is high, the amount of conduction auxiliary agent is increased.

Here, an aluminum foil is used as the positive electrode current collector 200, and the slurry is dropped thereon and is thinly spread by a casting method. Then, after the slurry is further stretched by a roller press machine and the thickness is made uniform, the positive electrode active material layer 201 is formed over the positive electrode current collector 200 by vacuum drying (under a pressure of less than or equal to 10 Pa) or heat drying (at a temperature of 150° C. to 280° C.). As the thickness of the positive electrode active material layer 201, a desired thickness is selected from the range of 20 μm to 100 μm. It is preferable to adjust the thickness of the positive electrode active material layer 201 as appropriate so that cracks and separation do not occur. Further, it is preferable that cracks and separation be made not to occur on the positive electrode active material layer 201 not only when the positive electrode current collector is flat but also when the positive electrode current collector is rolled into a cylinder shape, though it depends on the form of the lithium-ion secondary battery.

As the negative electrode current collector 205, a material having high conductivity such as copper, stainless steel, or iron can be used.

As the negative electrode active material layer 206, lithium, aluminum, graphite, silicon, germanium, or the like is used. The negative electrode active material layer 206 may be formed over the negative electrode current collector 205 by a coating method, a sputtering method, an evaporation method, or the like. Note that it is possible to omit the negative electrode current collector 205 and use any one of the materials alone as the negative electrode active material layer 206. The theoretical lithium insertion capacities are each larger in germanium, silicon, lithium, and aluminum than that in graphite. When the occlusion capacity is large, charge and discharge can be performed sufficiently even in a small area and a function as a negative electrode can be obtained; therefore, cost reduction and miniaturization of a secondary battery can be realized. However, countermeasures against deterioration are needed because there are the following problems: in the case of silicon or the like, the volume is increased approximately fourth times as large as the volume before lithium insertion so that the material itself becomes vulnerable, and a reduction in charge and discharge capacity due to repetition of charge and discharge (i.e., cycle deterioration) becomes remarkable.

The electrolyte solution contains alkali metal ions which are carrier ions, and these ions are responsible for electrical conduction. As an example of the alkali metal ion, a lithium ion is given, for example.

The electrolyte solution 211 includes, for example, a solvent and a lithium salt dissolved in the solvent. Examples of the lithium salts include lithium chloride (LiCl), lithium fluoride (LiF), lithium perchlorate (LiClO₄), lithium fluoroborate (LiBF₄), LiAsF₆, LiPF₆, Li(C₂F₅SO₂)₂N, and the like.

Examples of the solvent for the electrolyte solution 211 include cyclic carbonates (e.g., ethylene carbonate (hereinafter abbreviated to EC), propylene carbonate (PC), butylene carbonate (BC), and vinylene carbonate (VC)); acyclic carbonates (e.g., dimethyl carbonate (DMC), diethyl carbonate (DEC), ethylmethyl carbonate (EMC), methylpropyl carbonate (MPC), methylisobutyl carbonate (MIBC), and dipropyl carbonate (DPC)); aliphatic carboxylic acid esters (e.g., methyl formate, methyl acetate, methyl propionate, and ethyl propionate); acyclic ethers (e.g., 1,2-dimethoxyethane (DME), 1,2-diethoxyethane (DEE), ethoxymethoxy ethane (EME), and γ-lactones such as γ-butyrolactone); cyclic ethers (e.g., tetrahydrofuran and 2-methyltetrahydrofuran); cyclic sulfones (e.g., sulfolane); alkyl phosphate ester (e.g., dimethylsulfoxide and 1,3-dioxolane, and trimethyl phosphate, triethyl phosphate, and trioctyl phosphate); and fluorides thereof. All of the above solvents can be used either alone or in combination as the electrolyte solution 211.

As the separator 210, paper, nonwoven fabric, a glass fiber, a synthetic fiber such as nylon (polyamide), vinylon (also called vinalon) (a polyvinyl alcohol based fiber), polyester, acrylic, polyolefin, or polyurethane, or the like may be used. However, a material which does not dissolve in the above-described electrolyte solution 211, should be selected.

More specific examples of materials for the separator 210 are high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane, derivatives thereof, cellulose, paper, and nonwoven fabric, all of which can be used either alone or in combination.

When charge of the lithium-ion secondary battery described above is performed, a positive electrode terminal is connected to the first electrode 221 and a negative electrode terminal is connected to the second electrode 222. An electron is taken away from the positive electrode 202 through the first electrode 221 and transferred to the negative electrode 207 through the second electrode 222. In addition, a lithium ion is eluted from the positive electrode active material in the positive electrode active material layer 201 from the positive electrode, reaches the negative electrode 207 through the separator 210, and is taken in the negative electrode active material in the negative electrode active material layer 206. At the same time, in the positive electrode active material layer 201, an electron is released outside from the positive electrode active material, and an oxidation reaction of a transition metal (one or more of iron, manganese, cobalt, and nickel) contained in the positive electrode active material occurs.

At the time of discharge, in the negative electrode 207, the negative electrode active material layer 206 releases lithium as an ion, and an electron is transferred to the second electrode 222. The lithium ion passes through the separator 210, reaches the positive electrode active material layer 201, and is taken in the positive electrode active material in the positive electrode active material layer 201. At that time, an electron from the negative electrode 207 also reaches the positive electrode 202, and a reduction reaction of the transition metal (one or more of iron, manganese, cobalt, and nickel) contained in the positive electrode active material occurs.

The smaller the ratio c of the thickness d of the second region 104 to the grain size r of the particle of the positive electrode active material 100 (c=d/r) is, the larger the energy density obtained in this embodiment becomes. The ratio c is preferably greater than or equal to 0.005 and less than or equal to 0.25, more preferably greater than or equal to 0.01 and less than or equal to 0.1. The ratio c may be changed as appropriate in accordance with the desired energy density.

The lithium-ion secondary battery manufactured in the above manner includes a compound containing nickel as the positive electrode active material. Since nickel is contained in the positive electrode active material, a high discharge potential is realized. For example, there is a difference between positive electrode active materials having an olivine structure and containing different transition metals; however, the theoretical capacities per unit weight of the active material are almost the same. Therefore, the higher the discharge potential is, the more likely a high energy density is to be obtained.

For the organic solvent used in the electrolyte solution, a material having a wide potential window, that is, a material having a large difference between the oxidation potential and the reduction potential should be selected. The reason of this is as follows: in the case where an organic solvent having a small difference between the oxidation potential and the reduction potential is used, an oxidation-reduction reaction of the organic solvent is started and the organic solvent is decomposed before the potential reaches a potential at which charge and discharge are possible, so that charge and discharge of lithium cannot be performed. Note that the oxidation potential and the reduction potential of the electrolyte solution can be confirmed by a cyclic voltammetry method or the like. It is necessary to use an organic solvent whose potential window is wider than the width of the charge and discharge potential expected in the case of using a positive electrode active material including a compound containing lithium and nickel.

However, when a battery is manufactured with the use of a positive electrode material including a phosphate compound having an olivine structure and containing lithium and nickel (e.g., LiNiPO₄) and with the use of an organic solvent whose potential window is higher than the width of the charge and discharge potential expected in the case of using a positive electrode material including a phosphate compound having an olivine structure and containing lithium and nickel, charge and discharge cannot be performed because a catalyst effect of nickel causes the decomposition of the solvent before the potential reaches the expected value.

One the other hand, although the energy density does not reach a value expected in the case of using only lithium nickel phosphate (LiNiPO₄), a catalyst effect of nickel can be suppressed with the use of the positive electrode active material 100 which is obtained in this embodiment and includes the first region 102 that includes a compound containing lithium and nickel and the second region 104 that covers the entire surface of the first region 102 and includes a compound containing lithium and one or more of iron, manganese, and cobalt, but not containing nickel. Thus, charge and discharge can be realized. Accordingly, the energy density can be increased.

### Embodiment 5

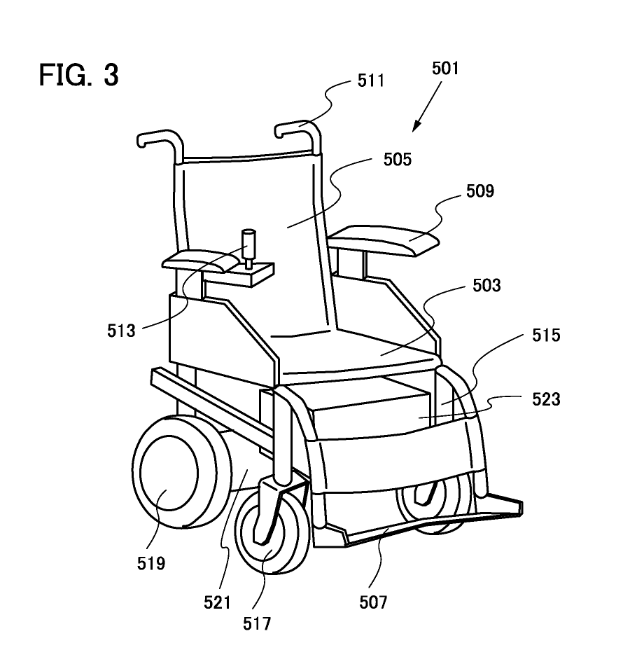

In this embodiment, an application example of the power storage device described in Embodiment 4 is described with reference to FIG. 3.

The power storage device described in Embodiment 4 can be used in electronic devices such as cameras like digital cameras or video cameras, mobile phones (also referred to as cellular phones or cellular phone devices), digital photo frames, portable game machines, portable information terminals, and audio reproducing devices. Further, the power storage device can be used in electric propulsion vehicles such as electric vehicles, hybrid vehicles, train vehicles, maintenance vehicles, carts, wheelchairs, and bicycles. Here, as a typical example of the electric propulsion vehicles, a wheelchair is described.

FIG. 3 is a perspective view of an electric wheelchair 501. The electric wheelchair 501 includes a seat 503 where a user sits down, a backrest 505 provided behind the seat 503, a footrest 507 provided at the front of and below the seat 503, armrests 509 provided on the left and right of the seat 503, and a handle 511 provided above and behind the backrest 505. A controller 513 for controlling the operation of the wheelchair is provided for one of the armrests 509. A pair of front wheels 517 is provided at the front of and below the seat 503 through a frame 515 provided below the seat 503, and a pair of rear wheels 519 is provided behind and below the seat 503. The rear wheels 519 are connected to a driving portion 521 having a motor, a brake, a gear, and the like. A control portion 523 including a battery, a power controller, a control means, and the like is provided under the seat 503. The control portion 523 is connected to the controller 513 and the driving portion 521. The driving portion 521 is driven through the control portion 523 with the operation of the controller 513 by the user and the control portion 523 controls the operation of moving forward, moving back, turning around, and the like, and the speed of the electric wheelchair 501.

The power storage device described in Embodiment 4 can be used in the battery of the control portion 523. The battery of the control portion 523 can be charged by power supply from the outside using plug-in systems. Note that in the case where the electric propulsion vehicle is a train vehicle, the train vehicle can be charged by power supply from an overhead cable or a conductor rail.

This application is based on Japanese Patent Application serial no. 2010-104610 filed with Japan Patent Office on Apr. 28, 2010, the entire contents of which are hereby incorporated by reference.

What is claimed is:

1. A power storage device comprising:
a positive electrode comprising a positive electrode active material and a positive electrode current collector; and
a negative electrode which faces the positive electrode with an electrolyte provided between the negative electrode and the positive electrode,
wherein the positive electrode active material comprises:
a first region which includes a phosphate compound containing lithium and nickel; and
a second region which covers the first region and includes a compound containing lithium and one or more of iron, manganese, and cobalt, but not containing nickel.

2. The power storage device according to claim 1, wherein an axis direction of a crystal lattice of the first region and an axis direction of a crystal lattice of the second region in the positive electrode active material are the same.

3. The power storage device according to claim 1, wherein the positive electrode active material is in particle form.

4. A power storage device comprising:
a positive electrode comprising a positive electrode active material and a positive electrode current collector; and
a negative electrode which faces the positive electrode with an electrolyte provided between the negative electrode and the positive electrode,
wherein the positive electrode active material comprises:
a first region which includes a first phosphate compound containing lithium and nickel; and
a second region which covers the first region and includes a second phosphate compound containing lithium and one or more of iron, manganese, and cobalt, but not containing nickel.

5. The power storage device according to claim 4, wherein the first phosphate compound has an olivine structure.

6. The power storage device according to claim 4, wherein the second phosphate compound has an olivine structure.

7. The power storage device according to claim 4, wherein an axis direction of a crystal lattice of the first region and an axis direction of a crystal lattice of the second region in the positive electrode active material are the same.

8. The power storage device according to claim 4, wherein the positive electrode active material is in particle form.

9. A power storage device comprising:
a positive electrode comprising a positive electrode active material and a positive electrode current collector; and
a negative electrode which faces the positive electrode with an electrolyte provided between the negative electrode and the positive electrode,
wherein the positive electrode active material comprises:
a particle comprising a phosphate compound containing lithium and nickel; and
a layer covering the particle, the layer including a compound containing lithium and one or more of iron, manganese, and cobalt, but not containing nickel.

10. The power storage device according to claim 9, wherein an axis direction of a crystal lattice in the particle and an axis direction of a crystal lattice of the layer in the positive electrode active material are the same.

11. A power storage device comprising:
a positive electrode comprising a positive electrode active material and a positive electrode current collector; and
a negative electrode which faces the positive electrode with an electrolyte provided between the negative electrode and the positive electrode,
wherein the positive electrode active material comprises:
a particle comprising a first phosphate compound containing lithium and nickel; and
a layer covering the particle, the layer including a second phosphate compound containing lithium and one or more of iron, manganese, and cobalt, but not containing nickel.

12. The power storage device according to claim 11, wherein the first phosphate compound has an olivine structure.

13. The power storage device according to claim 11, wherein the second phosphate compound has an olivine structure.

14. The power storage device according to claim 11, wherein an axis direction of a crystal lattice in the particle and an axis direction of a crystal lattice of the layer in the positive electrode active material are the same.
